(19) United States
(12) Patent Application Publication
(10) Pub. No.: US 2014/0137831 A1
(43) Pub. Date: May 22, 2014

(54) Cylinder Bore Coating System

(71) Applicant: RZR Corporation, Stratford, CT (US)

(72) Inventors: Amitava Datta, East Greenwich, RI (US); Robert Z. Reath, Easton, CT (US); John D. Carpenter, Trumbull, CT (US)

(73) Assignee: RZR Corporation, Stratford, CT (US)

(21) Appl. No.: 14/085,936

(22) Filed: Nov. 21, 2013

Related U.S. Application Data
(60) Provisional application No. 61/729,162, filed on Nov. 21, 2012.

(51) Int. Cl. F02F 1/00

(52) U.S. Cl. CPC F02F 1/004
USPC 123/193.2

(57) ABSTRACT

Embodiments of the present innovation relate to a cylinder bore coating system which simultaneously combines both friction and wear properties to enhance engine efficiency and operating life. The cylinder bore coating system includes a relatively thin top layer, such as diamond like carbon layer (DLC), disposed over a thicker, relatively hard and high modulus coating (i.e., an under coating). This combination of layers provides both low friction as well as low wear characteristics to the engine bore, relative to conventional engine bore coatings.

### RELATED APPLICATIONS

This patent application claims the benefit of U.S. Provisional Application No. 61/729,162, filed on Nov. 21, 2012, entitled, “CYLINDER BORE COATING SYSTEM,” the contents and teachings of which are hereby incorporated by reference in their entirety.

### BACKGROUND

Conventional piston engines include multiple cylinder assemblies used to drive a crankshaft. During operation, friction generated between an engine bore and a corresponding piston ring of the cylinder assembly can result in substantial power loss by the engine. While engine power output could be improved by increasing the ring/bore interference, such an increase would increase frictional loss, thereby further limiting engine output.

To minimize power loss and to improve engine efficiency, manufacturers utilize a variety of engine block materials. For example, conventional engine blocks are made from either cast iron, such as compacted graphite, or hypereutectic Al—Si alloys. Compacted graphite is a special grade of cast iron where the associated graphite particles are interconnected and their morphology is configured as either a thick short flake or as spherical shape without any thin long graphite flakes found in standard cast iron. This unique morphology of compacted graphite provides relatively high strength, ductility, thermal conductivity, and damping capacity. Hypereutectic Al—Si alloys have relatively high Si (e.g., greater than 12 wt %) which is larger than the eutectic composition of conventional Al—Si alloys. Hypereutectic alloys have primary Si crystals which form first during solidification. These Si particles in the microstructure impart relatively high wear resistance.

Additionally, to minimize power loss and to improve engine efficiency, manufacturers typically utilize a variety of cylinder and piston ring coatings. To minimize friction, one of the coatings on either the piston or the cylinder bore is generally softer than the other.

For example, engine bores are generally coated with various low friction/low wear tribological coatings, including hard chrome and thermal spray coatings. Such conventional coatings are proprietary to high performance engine block manufacturers. Manufacturers typically apply engine or cylinder bore coatings as a relatively thick layer and plateau hone the thickness to a specified inner diameter. With reference to FIG. 1, plateau honing involves use of a coarse honing stone (i.e., having a relatively coarse grit) to form peaks 10 and valleys 12 in the coating 14, followed by the use of a relatively finer stone in a cross hatched manner to remove the peaks 10 from the coating 14. The plateau honing process creates flat plateau regions in the coating 14 separated by the valleys 12, which act as lubricating oil reservoirs.

Piston rings are generally manufactured from plain carbon steel and have a circumferential surface configured to contact the cylinder bore. With such a configuration, during operation, the piston rings can rub against the engine bore and generate friction within the bore. Accordingly, to minimize wear and friction, manufacturers coat the piston rings with relatively hard tribological coatings, such as hard chrome, as compared to conventional engine bore coatings.

### SUMMARY

By contrast to conventional coatings, embodiments of the present innovation relate to a cylinder bore coating system which simultaneously combines both relatively low friction and relatively low wear properties to enhance engine efficiency and operating life. The cylinder bore coating system can reduce the costs associated with engine refurbishing and turnaround time, where it is necessary to enlarge the bore, recoat and hone the enlarged cylinder bore, and use slightly larger piston rings for the enlarged bore. This is important for high performance and racing car engines.

In one arrangement, the cylinder bore coating system includes a relatively thin, low friction topcoat layer, such as diamond like carbon layer (DLC) disposed over a thicker, relatively hard and high modulus undercoat layer. This coating combination provides both low friction and low wear characteristics to the engine bore, relative to conventional engine bore coatings.

In one arrangement, the topcoat layer is configured as a relatively low friction layer and can be applied by a conventional Physical Vapor Deposition (PVD) type process. The thickness of the topcoat layer can be between about 2 μm and 10 μm in thickness, typical of a PVD process. While DLC can be utilized as the topcoat layer, other relatively hard PVD coatings such as TiN, CrN, TiAlNi, Cr₂O₃, and ZrO₂ can also be used for the topcoat layer.

The relatively hard and high modulus undercoat layer is configured as a thicker coating that can be applied to the cylinder bore by an electrolytic, electroless, or a thermal spray process. The thickness of the hard and high modulus undercoat layer can be between about 0.001 inches and 0.01 inches. The undercoat layer has a hardness that is greater than the hardness of the base material of the engine block which is typically made from cast iron or Al—Si alloys for example. For example, typical electrolytic coats can be Ni—SiC, Co—SiC, Ni—P—SiC, Co—P—SiC, and Ni—Co—P—SiC. Other than SiC, the hard ceramic particles can be any other tribological compounds with low friction and wear characteristics, such as chrome carbide, tungsten carbide, titanium carbide, for example.

Thermal spray coatings can be chrome carbide, tungsten carbide, chrome oxide, for example.

In one arrangement, an engine cylinder assembly includes an engine cylinder having a cylinder wall that defines a cylinder bore, a material of the engine cylinder having a first modulus of elasticity and a first hardness. The engine cylinder assembly includes a first layer disposed on the cylinder wall, the first layer having a second modulus of elasticity and a second hardness, the second modulus of elasticity being greater than the first modulus of elasticity of the engine cylinder and the second hardness being greater than the first hardness of the engine cylinder. The engine cylinder assembly includes a topcoat layer disposed on the first layer, the topcoat layer configured to minimize friction between the engine cylinder assembly and a piston ring disposed within the cylinder bore.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic illustration of plateau honing of conventional cylinder bore coatings.

FIG. 2 illustrates a cross-sectional view of an engine cylinder having cylinder bore coating system that includes a relatively thin low friction layer, such as a diamond like carbon layer (DLC), disposed over a relatively hard and high modulus coating layer, according to one arrangement.

FIG. 3 is a schematic representation of a reciprocating pin-on-coupon sliding wear test apparatus.

FIG. 4 is a graph showing the coefficient of friction of a chrome pin on a DLC over Ni—Co—P—SiC coated 4130 steel sample as a function of reciprocating cycles.

FIG. 5 is a graph showing the coefficient of friction of a chrome pin on a Ni—Co—P—SiC coated 4130 steel sample as a function of reciprocating cycles.

FIG. 6 is a graph showing the coefficient of friction of a chrome pin on a thermal sprayed Mo—B—Fe cylinder bore coating as a function of reciprocating cycles.

FIG. 7 is a graph showing the coefficient of friction of a chrome pin on a MoS₂ based piston coating over a hard Ni—Co—P—SiC coating as a function of reciprocating cycles.

FIG. 8 is a graph showing the coefficient of friction of a chrome pin on an electrocomposite Ni—SiC coating as a function of reciprocating cycles.

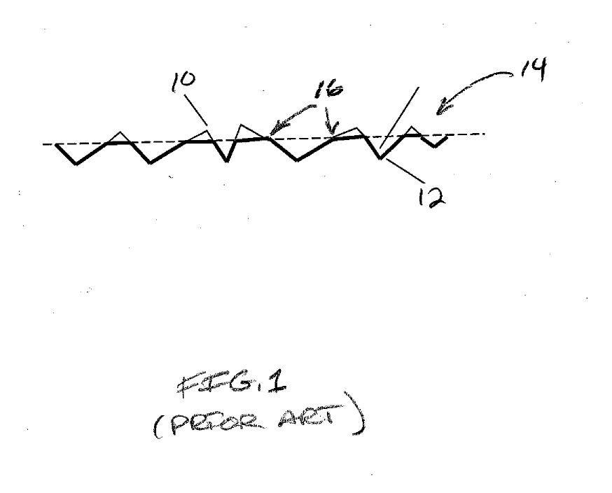

### DETAILED DESCRIPTION

Embodiments of the present innovation relate to a cylinder bore coating system which simultaneously combines both relatively low friction and low wear properties to enhance engine efficiency and operating life. The cylinder bore coating system includes a relatively thin, low friction top layer, such as diamond like carbon layer (DLC), disposed over a thicker, relatively hard and high modulus undercoat layer. This combination of layers provides both low friction as well as low wear characteristics to the cylinder bore, relative to conventional engine bore coatings. For example, to minimize the wear rate and the coefficient of friction associated with the cylinder bore, a manufacturer can apply the undercoat layer to the inner wall of the cylinder bore prior to application of the topcoat layer.

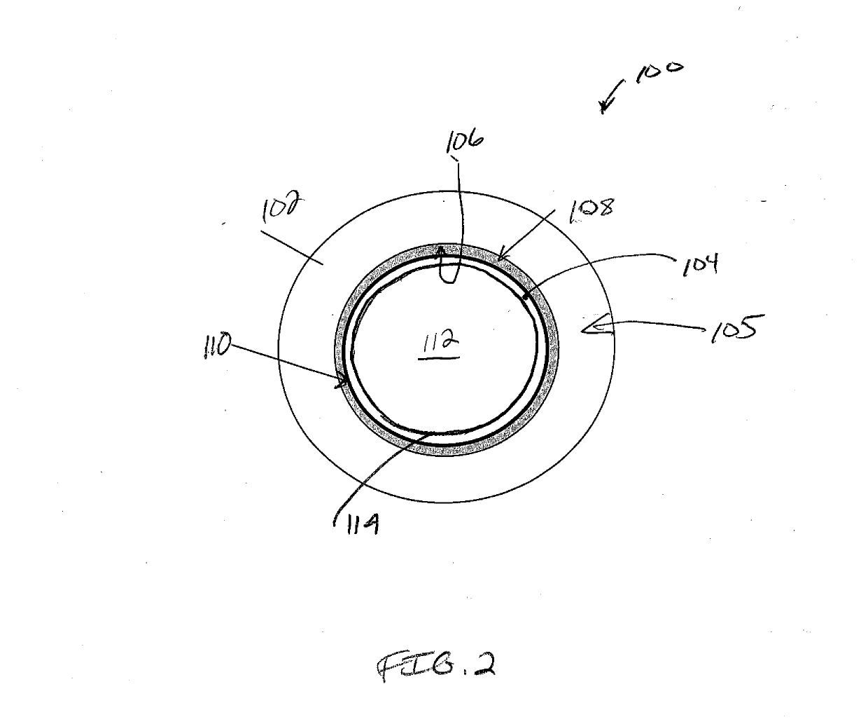

An automobile engine can include a number of engine cylinder assemblies. FIG. 2 illustrates a cross-sectional view of an example arrangement of an engine cylinder assembly 100. The cylinder assembly 100 includes an engine cylinder 102 defining a bore 104 where an inner wall 106 of the bore 104 includes a coating system 105. In one arrangement, the coating system 105 includes a relatively hard and stiff first or undercoat layer 108 having a relatively high modulus of elasticity and a second, relatively hard topcoat layer 110, such as a diamond like carbon (DLC) coating or other low friction material.

While the engine cylinder 102 can be manufactured from a variety of materials, in one arrangement, the engine cylinder or substrate 102 can be manufactured of various grades of cast iron such as compacted graphite, cast aluminum alloys such as hypereutectic Al—Si alloys, or wrought aluminum alloys, for example.

In one arrangement, the topcoat layer 110 is configured as a relatively low friction layer and can be applied by a conventional Physical Vapor Deposition (PVD) type process. While the topcoat layer 110 can be configured in a variety of ways, in one arrangement, the topcoat layer 110 is configured as a diamond like carbon (DLC) coating or other relatively hard PVD coatings such as TiN, CrN, TiAlNi, Cr₂O₃, and ZrO₂. While the topcoat layer 110 can be applied in a variety of thicknesses, in one arrangement, the topcoat layer 110 can be between about 2 μm and 10 μm in thickness.

In one arrangement, if the topcoat layer 110 (e.g., the DLC coating) is applied directly over a cast iron or Al—Si cylinder bore 102, both the wear rate and coefficient of friction of the cylinder bore 102 can be adversely affected. For example, during operation the relatively softer and lower modulus base material of the cylinder bore 102 can deform under high contact load. With such a configuration, the relatively thin topcoat layer 110 can deform along with the base material of the cylinder bore 102 and, being hard and relatively brittle, can crack. This can lead to three body wear during operation, which includes the lodging of the hard fragments of the topcoat layer 110 between a piston and cylinder bore as the surfaces rub together, thereby increasing wear rate and coefficient of friction. To minimize the wear rate and the coefficient of friction associated with the cylinder bore 102, a manufacturer can apply the hard and high modulus undercoat layer 108 to the inner wall 106 of the cylinder bore 102 prior to application of the thin low friction topcoat layer 110.

While the undercoat layer 108 can be made from a variety of materials, in one arrangement the undercoat layer 108 is made from Co—P, Ni—P, and/or Ni—Co—P alloy base electrocomposite coatings containing tribological particles such as SiC, Si₃N₄, BN, Cr₃C₂, WC, Al₂O₃ and other ceramic compounds with relatively high hardness and elastic modulus. In one arrangement, the undercoat layer 108 is produced via thermal sprayed alloys containing refractory metals such as W, Mo, Nb and Ta with relatively high modulus and hardness values. The thermal spray coating can be chrome carbide, tungsten carbide, or chrome oxide, for example. While the undercoat layer 108 can be applied in a variety of thicknesses, in one arrangement, the undercoat layer 108 can be between about 50 μm and 150 μm in thickness.

For example, modulus and hardness values for several ceramic compounds and refractory metals are shown in Table 1.

TABLE 1
Hardness and Elastic Modulus of Ceramic
Compounds and Refractory Metals

| Material | Hardness, Kg/mm² | Modulus, GPa |
|---|---|---|
| SiC | 2800 | 440 |
| Si₃N₄ | 1750 | 300 |
| WC | 1500 | 400 |
| Mo | 320 | 310 |
| W | 600 | 400 |

Modulus values of the coating can be estimated by the following relationship:

Coating modulus=(Vol. fraction of matrix)*Eₘₐₜᵣᵢₓ+(Vol. fraction of ceramic particle)*E_{ceramic}

For example, utilizing the relationship, the elastic modulus of a Ni—Co—P—SiC undercoat layer 108 containing 25 vol % SiC is given by:

Modulus of Ni—Co—P—SiC=0.75×210 GPa+0.25×450 GPa=267 GPa

This result is larger than the modulus of elasticity for typical cylinder block materials, such as cast iron which has a modulus of elasticity of about 200 GPa and such as Al—Si alloys which have a modulus of elasticity of about 70 GPa. Also the hardness of Ni—Co—P—SiC is about 700 VHN₁₀₀ (Vickers hardness Number) which is larger than about 200 VHN₁₀₀ for cast iron materials and than about 100 VHN₁₀₀ for Al—Si alloys.

The combination of the low friction topcoat layer 110 and the relatively high hardness and elastic modulus undercoat layer 108 exhibits unique characteristics of both low coefficient of friction (COF) and low wear rate when running against (e.g., rubbing against) a piston ring 112 coated with Cr, DLC and other conventional PVD coatings 114. As described below, this combination of low wear and low friction reduces engine power loss resulting from frictional heat and increases engine operating life. Accordingly, the use of the topcoat layer 110 and the undercoat layer 108 reduces the need for frequent remachining of bores and large inventory of piston rings of various sizes to fit the remachined enlarged cylinder bores.

Coefficient of friction and wear characteristics are not intrinsic properties of materials (such as hardness or tensile strength) but are defined by the systems characteristics of the rubbing surfaces, contact load, surface speed and the like. Accordingly, to test the effectiveness of the topcoat layer 110 and the undercoat layer 108 with respect to coefficient of friction and wear, a Linearly Reciprocating Pin-on-Flat Coupon Sliding Wear Test (ASTM G-95) was conducted on several samples. The reciprocating test simulated the motion of a piston ring over a cylinder bore. All tests were conducted without any lubricating oil to represent the worst case of a lubrication-starved engine cylinder. The objective was to distinguish between the best performing piston ring/cylinder bore coating tribo-pair described above and conventional tribo-pairs where the tribo-pair is the combination of two rubbing surfaces, e.g., the piston ring and cylinder bore surfaces.

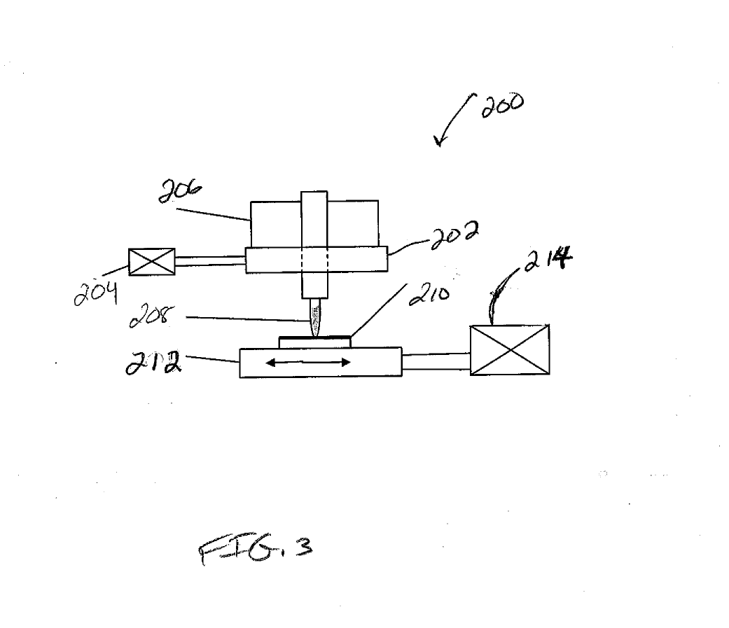

FIG. 3 illustrates a schematic representation of a reciprocating pin-on-coupon sliding wear test apparatus 200. The apparatus 200 includes a support platform 202 coupled to a strain gauge 204 and configured to carry a dead weight 206. The support platform 202 also includes a hardened steel pin 208 coated with hard chrome to represent a piston ring. The pins 208 were loaded with the dead weight 206 to apply a relatively large Hertzian contact load on a coated coupon 210 mounted on a reciprocating platform 212. The reciprocating platform is driven by a reciprocating motor 214 during operation. Wear tests were conducted with a 30 N dead weight and 400 m wear distance.

Both coupon 210 and pin 208 were polished to a mirror finish. The pin 208 was mounted substantially vertical to the platform 202 to apply the dead weight or load (N) 206 substantially normal to the coupon 210. The strain gage 204 was attached to the platform 202 to measure tangential force H. The coefficient of friction (COF) was estimated in real time using a data logger (not shown) by dividing H by N (COF=H/N). Plots of moving point averages of 20 COF values were plotted against the number of reciprocating cycles. Wear volume was estimated by measuring the weight loss and dividing the weight loss with the corresponding density. Wear coefficient is defined as,

Wear coefficient=wear vol., mm³/load, N×wear distance, m

The following provide the results of several tests conducted.

### Example I

### Effect of DLC Coating Over a Hard/High Modulus Coating

Table 2 summarizes weight loss and wear coefficient of two tribo-pairs. For the first tribo-pair, a chrome plated pin 208 was used on a reciprocating coupon 210 plated with a thin DLC coated directly over a 4130 steel coupon which is expected to perform better than cast iron because of better adhesion of DLC coating. For a comparative study, 4130 steel as a base material is expected to have a trend similar to that of cast iron and hypereutectic Al—Si. For the second tribo-pair, a chrome plated pin 208 was used over a duplex (i.e. topcoat 110 and undercoat 108) coating consisting of a thin DLC coating 110 over a hard and high modulus Ni—Co—P—SiC electrocomposite coating 108 over a 4130 steel coupon. Hardness of Ni—Co—P—SiC is about 800 VHN₁₀₀ and that of 4130 steel is about 300 VHN₁₀₀. The modulus of Ni—Co—P—SiC is about 267 GPa and that of 4130 steel is 200 GPa.

TABLE 2
Effect of DLC over a hard/high modulus coating
on Weight Loss and Wear Coefficient

| | Weight Loss, gms | | Wear Coeff. mm³/Nm | |
|---|---|---|---|---|
| Tribo Pair | Pin | Coupon | Pin | Coupon |
| Chrome Pin on DLC | Not | 0.0235 | — | 25 × 10⁻⁵ |
| coated 4130 (2500 cycles) | measured | | | |
| Chrome Pin on DLC over | Not | 0.0003 | — | 0.35 × 10⁻⁵ |
| hard Ni—Co—P—SiC | measured | | | |
| coated 4130 (3500 cycles) | | | | |

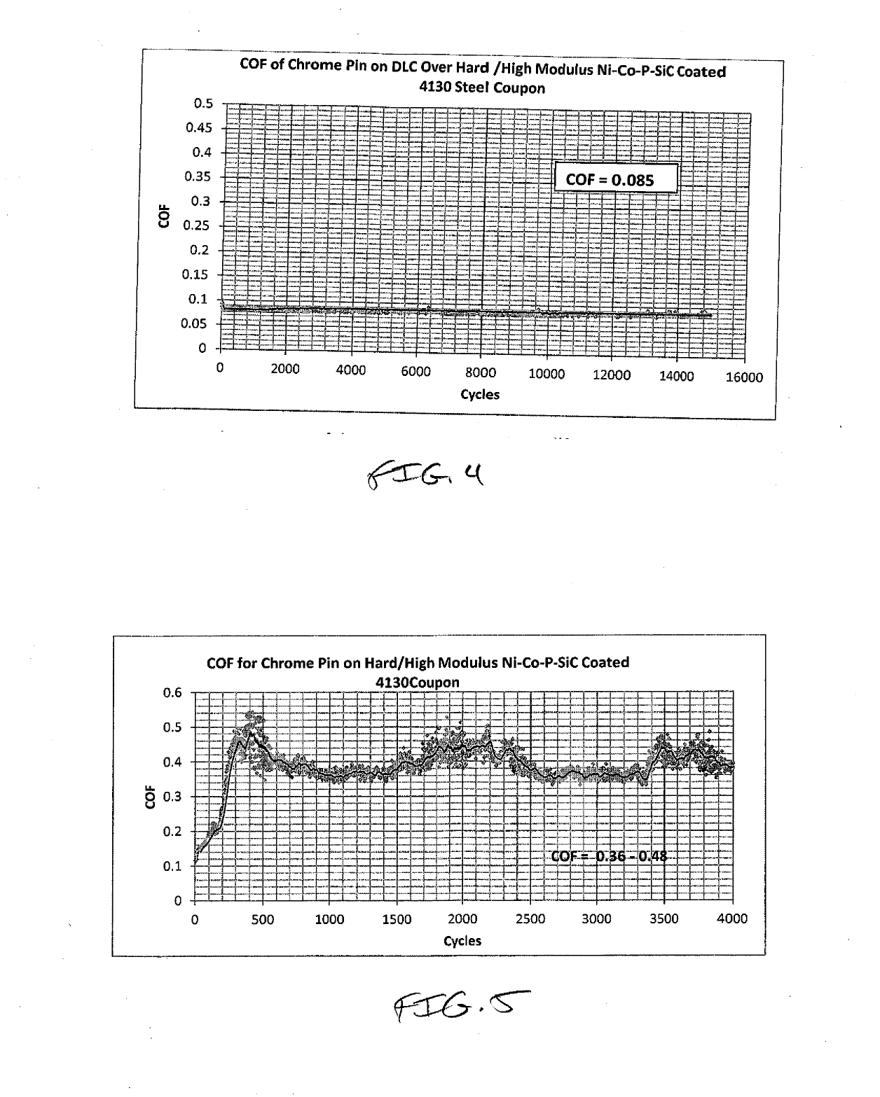

Based on the test, the duplex coating DLC over a hard Ni—Co—P—SiC electrocomposite coating has a significantly lower wear coefficient compared to straight DLC over a base 4130 coupon which is much softer than Ni—Co—P—SiC . It is possible that chrome pin 208 broke through the thin hard brittle DLC coating because of the deflection of the softer 4130 support base material and resulted in three body wear and a high wear coefficient. Coefficient of friction values of chrome pin 208 on DLC over a hard Ni—Co—P—SiC electrocomposite coating on 4130 coupon and a chrome pin 208 on just Ni—Co—P—SiC coated 4130 coupon without DLC are compared in FIGS. 4 and 5.

Accordingly, the addition of DLC coating on hard Ni—Co—P—SiC coating significantly reduced the COF compared to just Ni—Co—P—SiC coating. It should be noted that COF remained constant for the DLC over Ni—Co—P—SiC throughout the test whereas, COF increased from 0.15 to 0.4 after about 500 cycles for Ni—Co—P—SiC without-the top layer of DLC.

### Example II

### DLC+Ni—Co—P—SiC vs. State-of-the-Art Thermal Sprayed Fe—B—Mo Coating

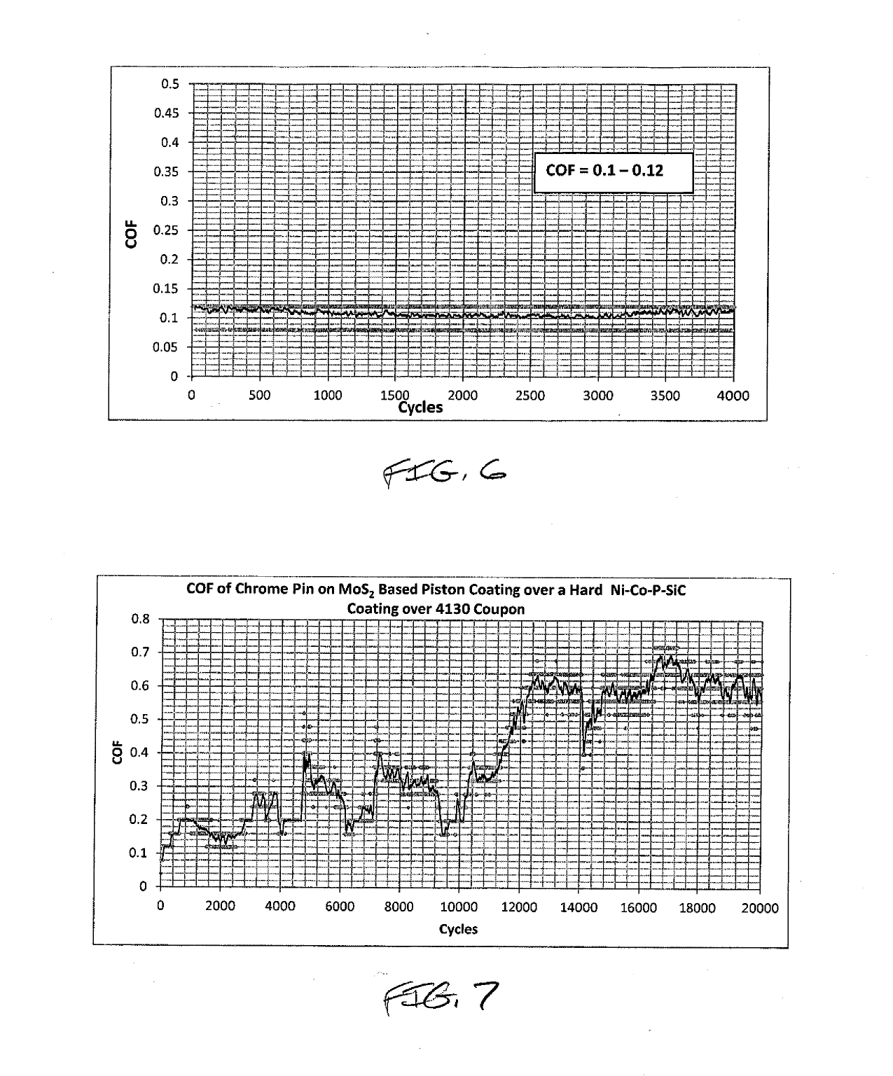

Reciprocating wear and friction tests were conducted with a chrome plated steel pin 208 and a conventional thermal sprayed Fe—Mo—B coating, typically used for high performance engine bore. FIG. 6 illustrates the COF as a function of reciprocating cycles.

Based upon the results, the COF of this coating is somewhat higher than that of DLC applied to Ni—Co—P—SiC running against hard chrome, 0.1-0.12 vs. 0.08. However, wear tests showed deep wear scars on the thermal sprayed Mo—B—Fe coatings, whereas, the combination DLC and Ni—Co—P—SiC coating had hardly discernible wear scar and a significantly low wear coefficient (e.g., as indicated in Table 2).

### Example III

### Effect of a Solid Lubricant MoS₂ Over a HardCoating Ni—Co—P—SiC

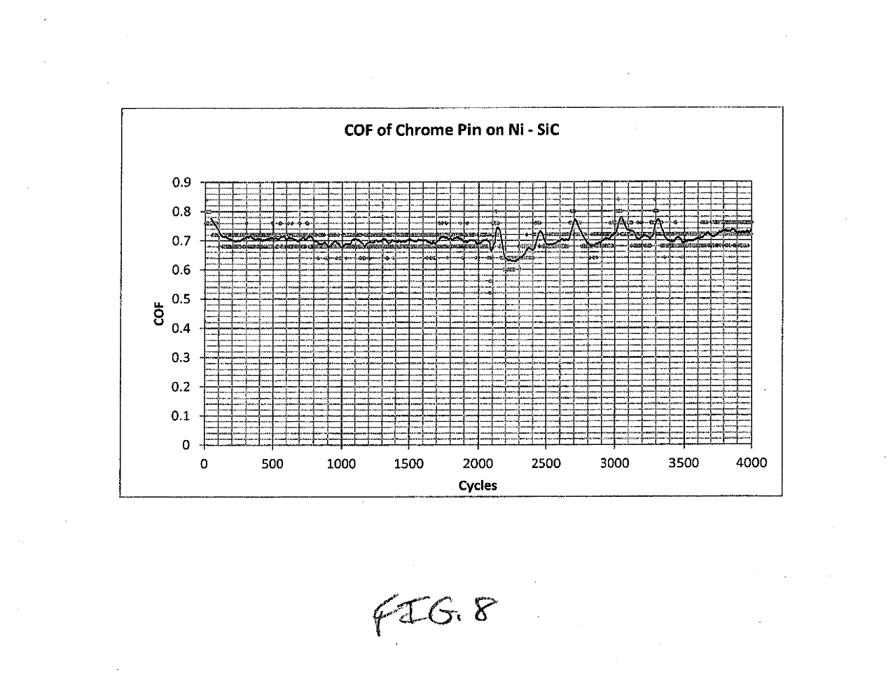

Reciprocating friction and wear tests were conducted using a chrome pin 208 running against a MoS₂ base low COF coating, conventionally used for pistons, disposed over a hard Ni—Co—P—SiC layer. FIG. 7 illustrates the variation of COF for this sample as a function of reciprocating cycle.

It is clear that a current MoS₂ solid lubricant containing coating over a hard Ni—Co—P—SiC coating over 4130 coupon had a low COF about 0.08 at the beginning; however, it increased to 0.2 within about 1000 cycles and as high as 0.7 at about 17,000 cycles compared to 0.08 throughout the entire 15,000 cycles with DLC over Ni—Co—P—SiC (e.g., as indicated in FIG. 4).

### Example IV

### State-of-the-art Electrocomposite Coating vs. DLC Over a Hard Ni—Co—P—SiC Coating

Reciprocating friction and wear tests were conducted with a conventional electrocomposite coating that includes Ni and SiC particles. COF results are shown in FIG. 8.

Based upon the results, the COF of the chrome pin 208 on Ni—SiC (COF of about 0.7) is substantially higher than that of DLC over hard/high modulus Ni—Co—P—SiC coating.

While various embodiments of the innovation have been particularly shown and described, it will be understood by those skilled in the art that various changes in form and details may be made therein without departing from the spirit and scope of the innovation as defined by the appended claims.

What is claimed is:

1. An engine cylinder assembly, comprising:
an engine cylinder having a cylinder wall that defines a cylinder bore, a material of the engine cylinder having a first modulus of elasticity and a first hardness;
a first layer disposed on the cylinder wall, the first layer having a second modulus of elasticity and a second hardness, the second modulus of elasticity being greater than the first modulus of elasticity of the engine cylinder and the second hardness being greater than the first hardness of the engine cylinder; and
a topcoat layer disposed on the first layer, the topcoat layer configured to minimize friction between the engine cylinder assembly and a piston ring disposed within the cylinder bore.

2. The engine cylinder assembly of claim 1, wherein the topcoat layer comprises a coefficient of friction of about 0.085.

3. The engine cylinder assembly of claim 1, wherein the topcoat layer comprises a Physical Vapor Deposition (PVD) layer.

4. The engine cylinder assembly of claim 3, wherein the PVD layer comprises a diamond-like carbon material.

5. The engine cylinder assembly of claim 3, wherein the PVD layer is selected from the group consisting of TiN, CrN, TiAlNi, Cr₂O₃, and ZrO₂.

6. The engine cylinder assembly of claim 1, wherein the first layer comprises an alloy base electrocomposite coating containing ceramic particles.

7. The engine cylinder assembly of claim 6, wherein the ceramic particles are configured as tribological compounds.

8. The engine cylinder assembly of claim 1, wherein the first layer comprises a thermal sprayed alloy material containing at least one refractory metal.

9. An engine cylinder assembly, comprising:
an engine cylinder having a cylinder wall that defines a cylinder bore, a material of the engine cylinder having a first modulus of elasticity and a first hardness;
a first layer disposed on the cylinder wall, the first layer having a second modulus of elasticity and a second hardness, the second modulus of elasticity being greater than the first modulus of elasticity of the engine cylinder and the second hardness being greater than the first hardness of the engine cylinder; and
a Physical Vapor Deposition (PVD) layer disposed on the first layer.

10. The engine cylinder assembly of claim 9, wherein the PVD layer comprises a diamond-like carbon material.

11. The engine cylinder assembly of claim 9, wherein the PVD layer comprises a TiN material.

12. The engine cylinder assembly of claim 9, wherein the PVD layer comprises a CrN material.

13. The engine cylinder assembly of claim 9, wherein the PVD layer comprises a TiAlNi material.

14. The engine cylinder assembly of claim 9, wherein the PVD layer comprises a Cr₂O₃ material.

15. The engine cylinder assembly of claim 9, wherein the PVD layer comprises a ZrO₂ material.

16. The engine cylinder assembly of claim 9, wherein the first layer comprises an alloy base electrocomposite coating containing ceramic particles.

17. The engine cylinder assembly of claim 16, wherein the ceramic particles are configured as tribological compounds.

18. The engine cylinder assembly of claim 9, wherein the first layer comprises a thermal sprayed alloy material containing at least one refractory metal.

19. An engine cylinder assembly, comprising:
an engine cylinder having a cylinder wall that defines a cylinder bore, a material of the engine cylinder having a first modulus of elasticity and a first hardness;
a first layer disposed on the cylinder wall, the first layer configured as one of (i) an alloy base electrocomposite coating containing ceramic particles and (ii) a thermal sprayed alloy material containing at least one refractory metal, the first layer having a second modulus of elasticity and a second hardness, the second modulus of elasticity being greater than the first modulus of elasticity of the engine cylinder and the second hardness being greater than the first hardness of the engine cylinder; and
a topcoat layer disposed on the first layer, the topcoat layer configured to minimize friction between the engine cylinder assembly and a piston ring disposed within the cylinder bore.

20. The engine cylinder assembly of claim 19, wherein the engine cylinder comprises a cast iron material.

21. The engine cylinder assembly of claim 19, wherein the engine cylinder comprises an Al—Si alloy.
